(19) United States
(12) Patent Application Publication
(10) Pub. No.: US 2012/0039533 A1
(43) Pub. Date: Feb. 16, 2012

(54) IMAGE PROCESSING APPARATUS AND DISPLAYING METHOD OF THE SAME

(75) Inventors: Young-ran HAN, Suwon-si (KR); Young-hoon CHO, Seoul (KR)

(73) Assignee: SAMSUNG ELECTRONICS CO., LTD., Suwon-si (KR)

(21) Appl. No.: 13/176,261

(22) Filed: Jul. 5, 2011

(30) Foreign Application Priority Data
Aug. 12, 2010 (KR) 10-2010-0077784

(51) Int. Cl. G06K 9/46

(52) U.S. Cl. 382/170; 382/195

(57) ABSTRACT

Disclosed are an image processing apparatus and a displaying method of the same, the display apparatus including: a display unit which displays an image thereon; a pattern extractor which extracts, from a texture source image, a texture pattern image that is smaller in size than the texture source image; and an image processor which changes a texture of the image to be displayed on the display unit by using the texture pattern image. Accordingly, a texture pattern image is generated from a texture source image.

### CROSS-REFERENCE TO RELATED APPLICATION

This application claims priority from Korean Patent Application No. 10-2010-0077784, filed on Aug. 12, 2010 in the Korean Intellectual Property Office, the disclosure of which is incorporated herein in its entirety by reference.

### BACKGROUND

1. Field

Apparatuses and methods consistent with the exemplary embodiments relate to an image processing apparatus and a displaying method of the same, and more particularly, to an image processing apparatus and a displaying method of the same which adjusts a texture of an image.

2. Description of the Related Art

A display apparatus may display an input image with various effects added. As digital cameras are widely used, various algorithms have been developed to adjust a captured still image. As one of effects used for displaying an image, a texture effect changes a texture of an image to appear as if the image is displayed on a canvas, a paper, a wall, etc.

A portable display apparatus that is widely used or a small display apparatus such as an electronic frame has a limitation in storing data for additional operations due to its limited storage.

### SUMMARY

Accordingly, one or more exemplary embodiments provide a display apparatus and a displaying method of the same which changes a texture of an image while occupying less storage space.

Furthermore, one or more exemplary embodiments provide a display apparatus and a displaying method of the same which generates a texture pattern image from a texture source image.

Moreover, one or more exemplary embodiments provide a display apparatus and a displaying method of the same which changes a degree of a texture and a distribution of a texture of a texture pattern image.

According to an aspect of an exemplary embodiment, there is provided a display apparatus including: a display unit which displays an image thereon; a pattern extractor which extracts, from a texture source image, a texture pattern image that is smaller in size than the texture source image; and an image processor which changes a texture of an image to be displayed on the display unit by using the texture pattern image.

The texture source image may include an M×N image (where 1≦M and 1≦N), and the pattern extractor may scan an m×n image (where 1≦m≦M and 1≦n≦N) to the M×N image and extract the m×n image in which a sum of absolute difference (SAD) of a top horizontal line and a bottom horizontal line is lowest, as the texture pattern image.

The texture source image may include the M×N image (where 1≦M and 1≦N), and the pattern extractor may scan the m×n image (where 1≦m≦M and 1≦n≦N) to the M×N image and extract the m×n image in which a SAD of a far left vertical line and a far right vertical line is lowest, as the texture pattern image.

The texture source image may include an M×N image (where 1≦M and 1≦N), and the pattern extractor may scan an m×n image (where 1≦m≦M and 1≦n≦N) to the M×N image and calculate a SAD_{H} of top and bottom horizontal lines and a SAD_{V} of far left and far right vertical lines and extract the m×n image having a lowest value according to a following formula:

SAD=αx SAD_{H}+βx SAD_{V} (where 0≦α, β). [Formula 1]

The texture source image may include an M×N image (where 1≦M and 1≦N), and the pattern extractor may extract an m×n image (where 1≦m≦M and 1≦n≦N) from the M×N image, and low-pass-filter pixels in a fringe of the m×n image to generate the texture pattern image.

The texture source image may include an M×N image (where 1≦M and 1≦N), and the pattern extractor may extract an a×b image (where 1≦a≦M and 1≦b≦N) from the M×N image, and interpolate the a×b image and generate the texture pattern image of an m×n image (where a≦m≦M and b≦n≦N).

The display apparatus may further include a gray image converter which converts the texture source image into a gray image if the texture source image comprises a color image, and the pattern extractor may extract the texture pattern image from the gray image.

The gray image converter may generate the gray image by extracting one of red (R), green (G), and blue (B) components of the texture source image.

The gray image converter may generate the gray image by extracting a brightness value of the texture source image.

The display apparatus may further include a filtering unit which adjusts a degree of a texture of the texture pattern image.

The filtering unit may include at least one of a low pass filter, a median filter, a high pass filter and a sharpness filter.

The display apparatus may further include a histogram unit which adjusts a distribution of a texture of the texture pattern image.

The histogram unit may normalize a histogram with respect to the number of pixels corresponding to a gray scale value of the texture pattern image, and adjust at least one of a width and a central axis of the normalized histogram.

According to an aspect of another exemplary embodiment, there is provided a displaying method of a display apparatus, the displaying method including: extracting, from a texture source image, a texture pattern image which is smaller in size than the texture source image; and changing a texture of an image to be displayed by using the texture pattern image.

The texture source image may include an M×N image (where 1≦M and 1≦N) and the extracting the texture pattern image may include scanning an m×n image (where 1≦m≦M and 1≦n≦N) to the M×N image and calculating a SAD_{H} of top and bottom horizontal lines and a SAD_{V} of far left and far right vertical lines, and extracting the m×n image having the lowest value according to a following formula:

SAD=αx SAD_{H}+βx SAD_{V} (where 0≦α, β). [Formula 1]

The texture source image may include an M×N image (where 1≦M and 1≦N), and the extracting the texture pattern image may include extracting an m×n image (where 1≦m≦M and 1≦n≦N) from the M×N image, and generating the texture pattern image by low-pass-filtering pixels in a fringe of the m×n image.

The texture source image may include an M×N image (where 1≦M and 1≦N), and the extracting the texture pattern image may include extracting an a×b image (where 1≦a≦M and 1≦b≦N) from the M×N image, and generating the texture pattern image of an m×n image (where a≦m≦M and b≦n≦N) by interpolating the a×b image.

The displaying method may further include converting the texture source image into a gray image if the texture source image comprises a color image.

The displaying method may further include adjusting a degree of a texture of the texture pattern image.

The displaying method may further include adjusting a distribution of a texture of the texture pattern image.

According to an aspect of another exemplary embodiment, there is provided a method of generating a texture pattern image, the method including: extracting, from a texture source image, a texture pattern image which is smaller in size than the texture source image; and storing the extracted texture pattern image to be combined with an image to change a texture of the image.

### BRIEF DESCRIPTION OF THE DRAWINGS

The above and/or other aspects will become apparent and more readily appreciated from the following description of exemplary embodiments, taken in conjunction with the accompanying drawings, in which:

FIG. 1 is a control block diagram of a display apparatus according to an exemplary embodiment;

FIG. 2 illustrates a method of extracting a texture pattern image according to the exemplary embodiment;

FIGS. 3 and 4 illustrate a method of selecting a texture pattern image according to one or more exemplary embodiments;

FIG. 5 is a control flowchart of a displaying method of a display apparatus according to an exemplary embodiment;

FIGS. 6A and 6B illustrate a method of generating a texture pattern image according to another exemplary embodiment;

FIG. 7 is a control flowchart of a displaying method of a display apparatus according to another exemplary embodiment;

FIG. 8 is a control block diagram of a display apparatus according to another exemplary embodiment;

FIGS. 9A and 9B illustrate a filtering effect according to another exemplary embodiment;

FIG. 10 illustrates a histogram unit according to another exemplary embodiment; and

FIG. 11 is a control flowchart of a displaying method of a display apparatus according to another exemplary embodiment.

### DETAILED DESCRIPTION OF EXEMPLARY EMBODIMENTS

Below, exemplary embodiments will be described in detail with reference to accompanying drawings so as to be easily realized by a person having ordinary knowledge in the art. The exemplary embodiments may be embodied in various forms without being limited to the exemplary embodiments set forth herein. Descriptions of well-known parts are omitted for clarity, and like reference numerals refer to like elements throughout. Expressions such as “at least one of,” when preceding a list of elements, modify the entire list of elements and do not modify the individual elements of the list.

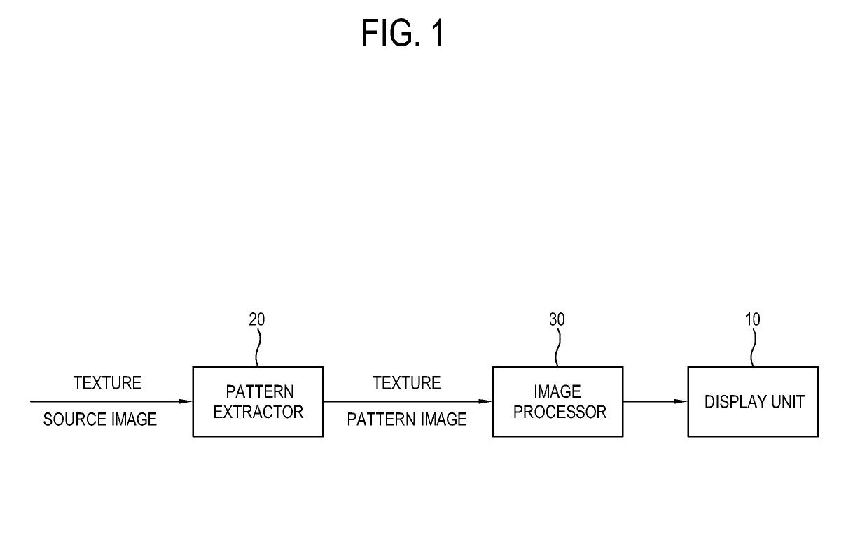

FIG. 1 is a control block diagram of a display apparatus according to an exemplary embodiment.

As shown in FIG. 1, the display apparatus includes a display unit 10, a pattern extractor 20 and an image processor 30. The display apparatus according to the present exemplary embodiment may be any audio/video device to display an image, including a monitor connected to a computer system, a television (TV), a small display apparatus such as an electronic frame and a portable terminal, etc. Furthermore, while the present exemplary embodiment described with reference to a display apparatus, it is understood that another exemplary embodiment is not limited thereto. For example, another exemplary embodiment may be implemented as an image processing device that does not display an image thereon, but outputs a processed image to be displayed by an external display device.

The display unit 10 displays thereon an image processed by the image processor 30. The display unit 10 may include a liquid crystal display (LCD) panel including a liquid crystal layer, an organic light emitting diode (OLED) panel including an organic light emitting diode, a plasma display panel (PDP), etc. The display unit 10 includes a panel driver to drive the panel.

The display apparatus may further include an image receiver (not shown) to receive an image. The image receiver may include at least one of a connector to be connected to a storage medium such as a universal serial bus (USB) memory or a camera storing pictures therein, an interface to be connected to a network, a broadcasting receiver to receive a broadcasting signal, etc. For example, the image receiver may include a Bluetooth unit, an infrared communication unit, a wired/wireless USB communication interface, etc.

The pattern extractor 20 extracts a texture pattern image which is smaller than a texture source image, from the texture source image. The texture refers to a feel of materials such as canvas, paper, a tree, a wall, etc. The texture source image refers to an image which acts as a basis for giving a texture effect to an input image. For example, the texture source image is combined with an input image or used to process an input image to provide the texture effect to the input image. The texture source image may have substantially the same size as the resolution of the display unit 10 or may have various sizes regardless of the size of an input image.

The pattern extractor 20 extracts a texture pattern image from the texture source image. The texture pattern image has a smaller size than the texture source image, and thus occupies a smaller storage space for the texture effect. Accordingly, various types of the texture pattern images according to one or more exemplary embodiments may be stored even in a limited storage space. Particularly, if a display apparatus includes an electronic frame or a mobile device and has a limited storage, such a texture pattern image may save the storage. Also, the texture pattern image provides the texture effect regardless of the size of an image, and therefore, the texture effect may be further utilized. A method of extracting the texture pattern image will be described in more detail below.

The image processor 30 changes a texture of an image to be displayed on the display unit 10 by using the texture pattern image, and outputs the changed image to the display unit 10. An algorithm which changes the texture of the image by using the texture pattern image may include all known or unknown methods. The image processor 30 may perform one or more additional processes, such as decoding a digital signal corresponding to a video and audio format, deinterlacing, converting a frame refresh rate, scaling, enhancing details, line-scanning the image, etc.

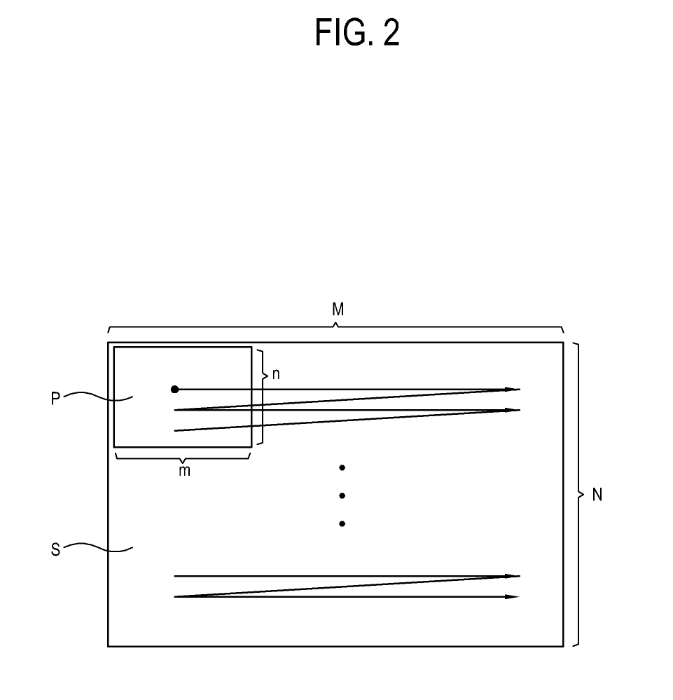

FIG. 2 illustrates a method of extracting a texture pattern image according to an exemplary embodiment.

As shown in FIG. 2, a texture source image S has a resolution of M×N (where 1≦M and 1≦N). The pattern extractor 20 scans an m×n image (where 1≦m≦M and 1≦n≦N) which is smaller than the M×N image, i.e., a temporary texture pattern image P, to the M×N image.

While scanning the temporary texture pattern image P to the texture source image S, the pattern extractor 20 calculates at least one of a sum of absolute difference (SAD)H of a top horizontal line and a bottom horizontal line of the temporary texture pattern image P and a SAD_{V} of a far left vertical line and a far right vertical line of the temporary texture pattern image P.

The calculated SAD_{V} and SAD_{H} are used to select a texture pattern image to be processed together with an image among temporary texture pattern images P.

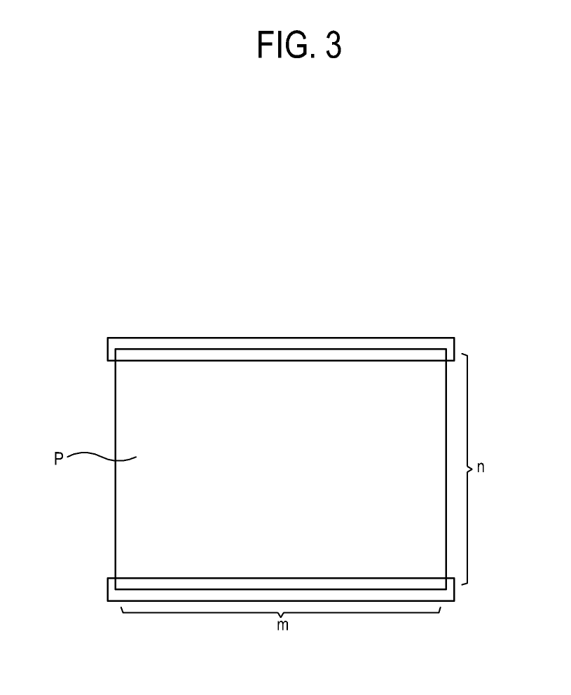

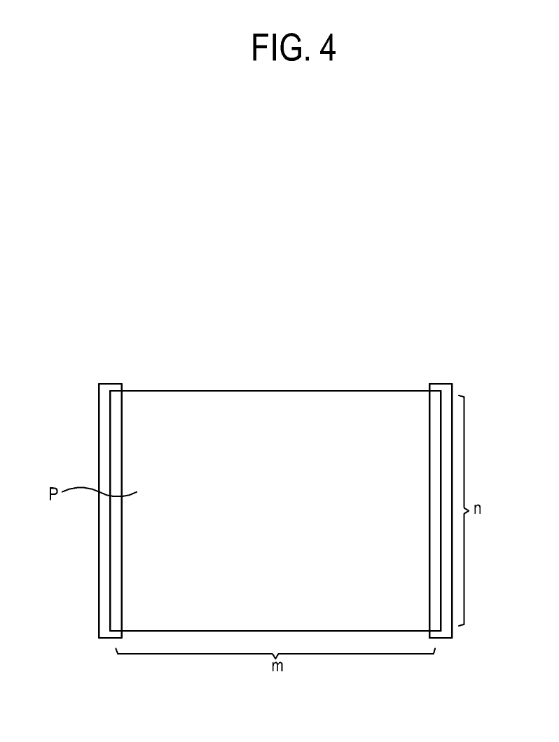

FIGS. 3 and 4 illustrate a method of selecting a texture pattern image according to one or more exemplary embodiments.

As shown in FIG. 3, the pattern extractor 20 may extract, as a texture pattern image, a temporary texture pattern image P in which the SAD_{H} of the top horizontal line and the bottom horizontal line is lowest.

Furthermore, as shown in FIG. 4, the pattern extractor 20 may extract, as a texture pattern image, a temporary texture pattern image P in which the SAD_{V} of the far left vertical line and the far right vertical line is lowest.

Moreover, the pattern extractor 20 may extract, as a texture pattern image, an m×n image which has the lowest value according to the following Formula 1. In Formula 1, α and β may include a positive real number including zero, and are coefficients which may be set by a user to differently adjust the ratio of SAD_{V} and SAD_{H}.

SAD=αx SAD_{H}+βx SAD_{V} (0≦α, β). [Formula 1]

If α is zero, the formula is an algorithm extracting a texture pattern image in consideration of only the SAD of the vertical line, as in FIG. 4. If β is zero, the formula is an algorithm extracting a texture pattern image in consideration of only the SAD of the horizontal line, as in FIG. 3.

The texture pattern image undergoes an image processing, such as being combined with an input image. Thus, if the boundary of the texture pattern image is clear, the image may be split or may have a linear noise. Accordingly, the pattern extractor 20 may select a texture source image S whose boundary is least discernible, and sets such an image as a texture pattern image.

According to another exemplary embodiment, the pattern extractor 20 may interpolate a temporary texture pattern image P having the smallest SAD_{H} and a temporary texture pattern image P having the smallest SAD_{V}, or generate a texture pattern image having an average of the foregoing values.

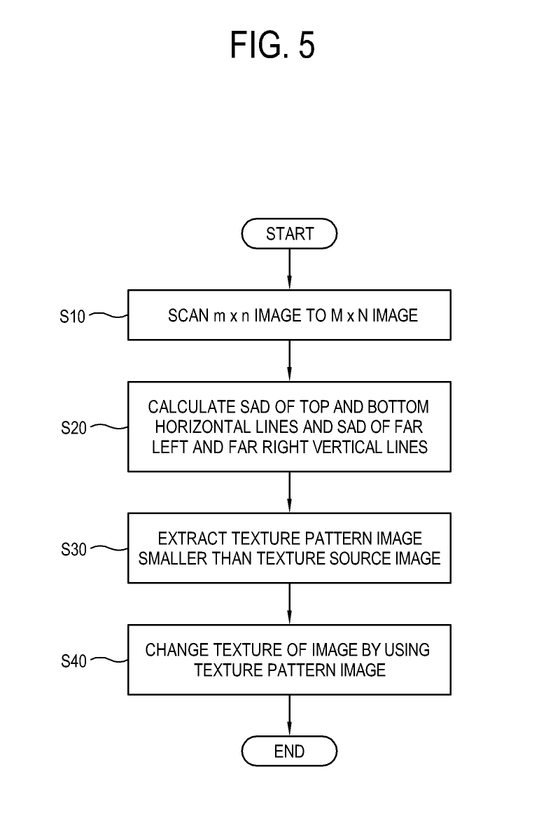

FIG. 5 is a control flowchart of a displaying method of a display apparatus according to an exemplary embodiment. In particular, a method of extracting a texture pattern image according to an exemplary embodiment will be described with reference to FIG. 5.

Referring to FIG. 5, a pattern extractor 20 scans an m×n image P to an M×N image as a texture source image S (operation S10).

During the scanning operation, the pattern extractor 20 calculates the SAD_{H} of the top horizontal line and the bottom horizontal line of a temporary texture pattern image P and the SAD_{V} of the far left vertical line and the far right vertical line of the temporary texture pattern image P (operation S20).

Then, the pattern extractor 20 extracts a texture pattern image having a smaller size than the texture source image S, from the texture source image S (operation S30).

An image in which the SAD_{H} of the top horizontal line and the bottom horizontal line is lowest or an image in which the SAD_{V} of the far left vertical line and the far right vertical line is lowest may be extracted as a texture pattern image, though it is understood that another exemplary embodiment is not limited thereto. For example, according to another exemplary embodiment, an image which satisfies a formula used to combine the foregoing two values may be extracted as a texture pattern image. The extracted texture pattern image is stored and supplied to an image processor 30.

The image processor 30 changes a texture of an image to be displayed on the display unit 10 by using the texture pattern image (operation S40). The image processor 30 may repeatedly use the texture pattern image, may sequentially use a plurality of texture pattern images, or may apply the texture pattern image to a certain part of an image to provide a texture effect.

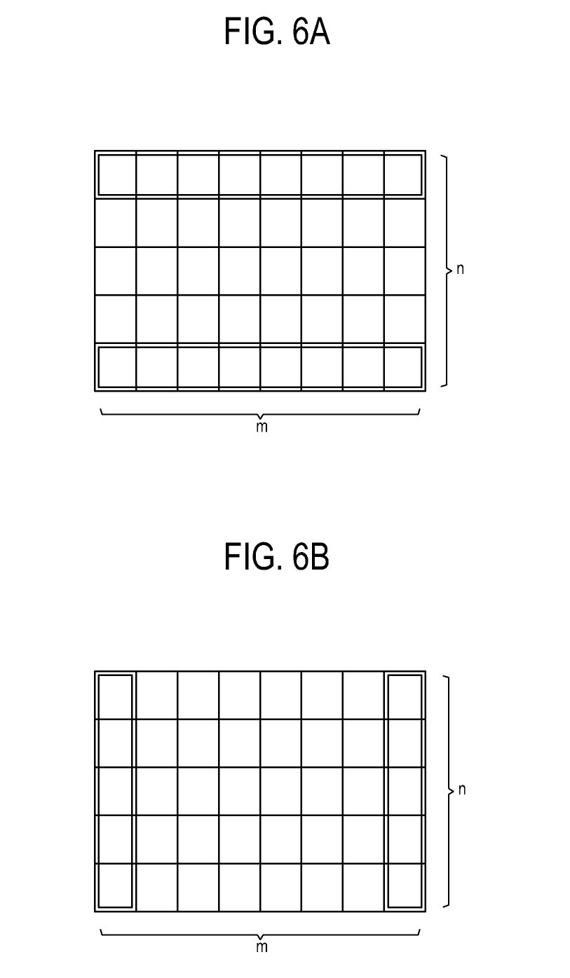

FIGS. 6A and 6B illustrate a method of generating a texture pattern image according to another exemplary embodiment. The pattern extractor 20 according to the present exemplary embodiment extracts an m×n image from an M×N image, low-pass-filters pixels in a fringe of the m×n image, and generates a texture pattern image. That is, the pattern extractor 20 low-pass-filters the top horizontal line and the bottom horizontal line as shown in FIG. 6A and low-pass-filters the far left vertical line and the far right vertical line as shown in FIG. 6B, and adjusts the boundary of the image.

According to the present exemplary embodiment, the pattern extractor 20 extracts a certain part from the the texture source image S and changes the boundary of the extracted m×n image without scanning the m×n image to the texture source image S to extract a texture pattern image, and therefore, the data processing is simple.

Other than the low pass filtering, the pattern extractor 20 may change a pixel value of a top horizontal line and a bottom horizontal line by using the average value of the top and bottom horizontal lines and change a pixel value of left and right lines by using the far left and right vertical lines. As the pixel value of the boundary of the texture pattern image is adjusted to be the same, the boundary is not distinctive even if the texture pattern image is repeatedly used to change the texture of the image.

According to another exemplary embodiment, the pattern extractor 20 may extract an a×b image (where 1≦a≦M and 1≦b≦N) having a lower resolution than the m×n image, and may interpolate the a×b image to generate a texture pattern image having the resolution of the m×n image. A given image, i.e., an a×b image which is smaller than the texture pattern image to be stored, may be extracted by using the texture source image S, and may undergo interpolation and low-pass-filtering to generate a texture pattern image.

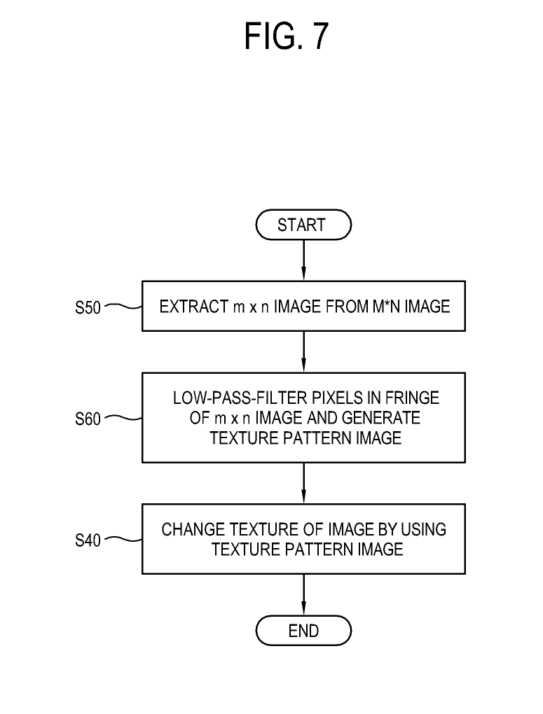

FIG. 7 is a control flowchart of a displaying method of a display apparatus according to another exemplary embodiment.

Referring to FIG. 7, a pattern extractor 20 extracts an m×n image from the M×N image (operation S50), and low-pass-filters the pixels in the fringe of the extracted m×n image and generates the texture pattern image (operation S60).

The pattern extractor 20 may scan the m×n image to the M×N image as in the exemplary embodiment described above with reference to FIG. 5 and calculate the SAD to extract the m×n image.

The texture of the input image is changed by the texture pattern image, and the changed image is displayed on a display unit 10 (operation S40).

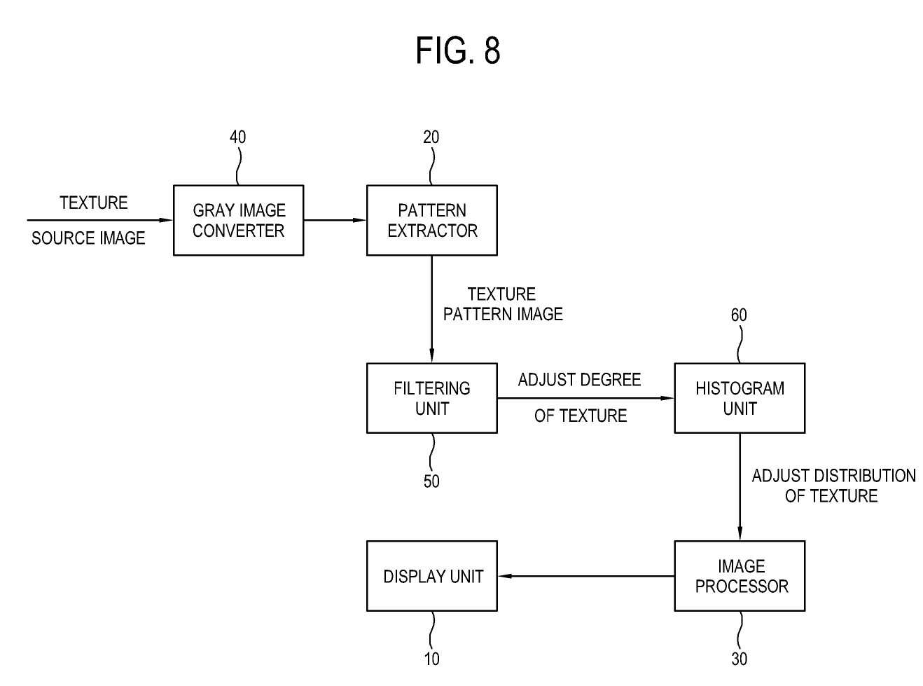

FIG. 8 is a control block diagram of a display apparatus according to another exemplary embodiment.

As shown in FIG. 8 and as compared to the display apparatus according to the exemplary embodiment illustrated in FIG. 1, the display apparatus further includes a gray converter 40, a filtering unit 50, and a histogram unit 60.

The gray converter 40 converts a texture source image into a gray image if a texture source image is a color image. The gray image refers to an image including color information. The gray converter 40 may generate a gray image by extracting at least one of red (R), green (G), and blue (B) components of the texture source image or by extracting a brightness value of the texture source image.

If the texture source image is a gray image in black and white, the image may bypass the gray converter 40.

The gray image is output to the pattern extractor 20 and a texture pattern image is extracted from the gray image according to the present exemplary embodiment.

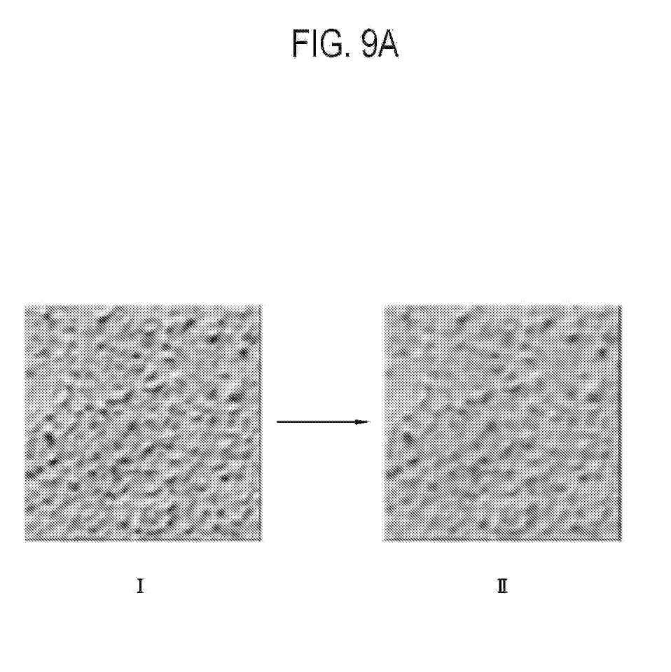

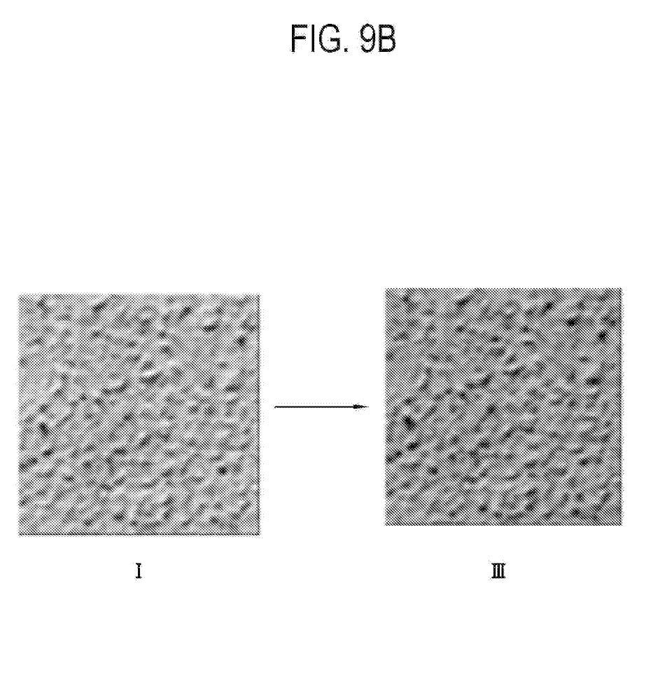

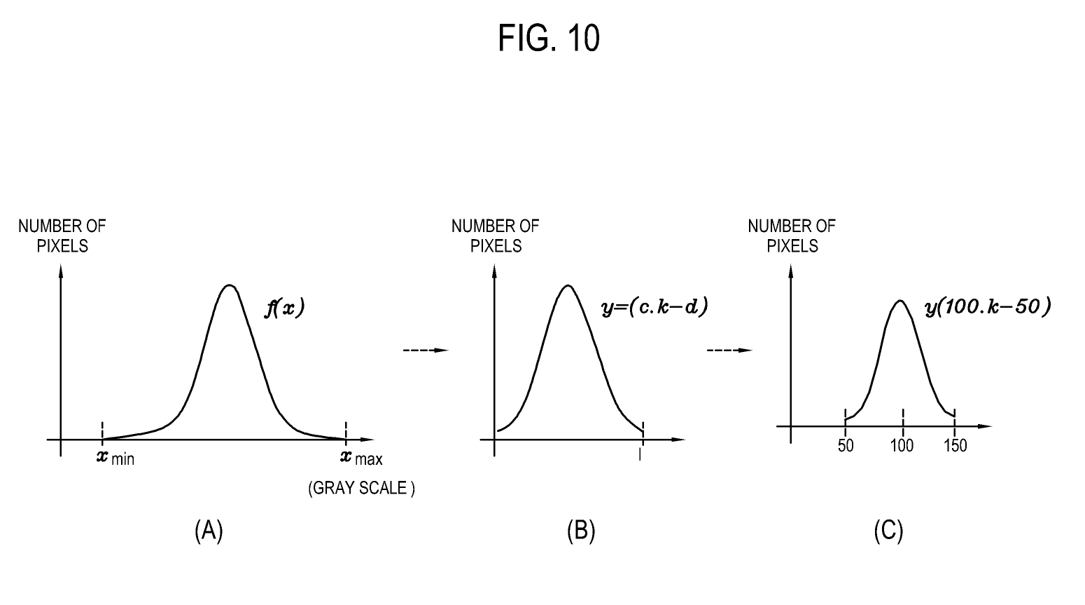

The filtering unit 50 may adjust a degree of a texture of the texture pattern image, and may include various filters to do the foregoing. For example, the filtering unit 50 may reinforce the texture effect, remove a noise from the texture, etc. FIGS. 9A and 9B illustrate the filtering effect according to the present exemplary embodiment. FIG. 9A illustrates a low frequency image II generated by filtering a texture pattern image I by a low pass filter or median filter. FIG. 9B illustrates a high frequency image III generated by filtering the texture pattern image I by a high pass filter and a sharpness filter.

As shown in FIG. 9A, the texture of the low frequency image II has noise removed from the original texture pattern image I, and thus, is smooth. Meanwhile, as shown in FIG. 9B, the texture of the high frequency image III becomes thick and coarse.

A user may selectively activate the operation of the filtering unit 50 or additionally control the degree of the texture by adjusting the number of filtering.

The histogram unit 60 adjusts a distribution of a texture of the texture pattern image. That is, the histogram unit 60 may adjust the distribution of the texture as wide or narrow, improve the texture effect by moving a certain part of the texture, etc.

FIG. 10 illustrates a histogram with respect to the number of pixels f(x) corresponding to a gray scale value x of the texture pattern image according to the present exemplary embodiment. It is assumed that a histogram of the texture pattern image input to the histogram unit 60 has a shape such as (A). The histogram unit 60 normalizes a histogram (A) like (B) (f(x)→y(ck−d), where 0≦k≦1, and c and d are real number). It is understood that the normalization method is known to one of ordinary skill in the art and is not limited to a particular method.

The histogram unit 60 adjusts a width and a central axis of the normalized histogram (B) and changes the distribution of the texture. (C) illustrates a histogram when c of the normalize histogram (B) is 100 and d is 50, where c is a scale coefficient adjusting the width of the histogram and d is a value to move the central axis of the histogram. c and d may have, as a maximum value, the maximum gray scale value with respect to pixels (e.g., in case of an 8-bit image signal, the maximum gray scale value is 28=255).

The histogram unit 60 may also be activated selectively according to a user's setting.

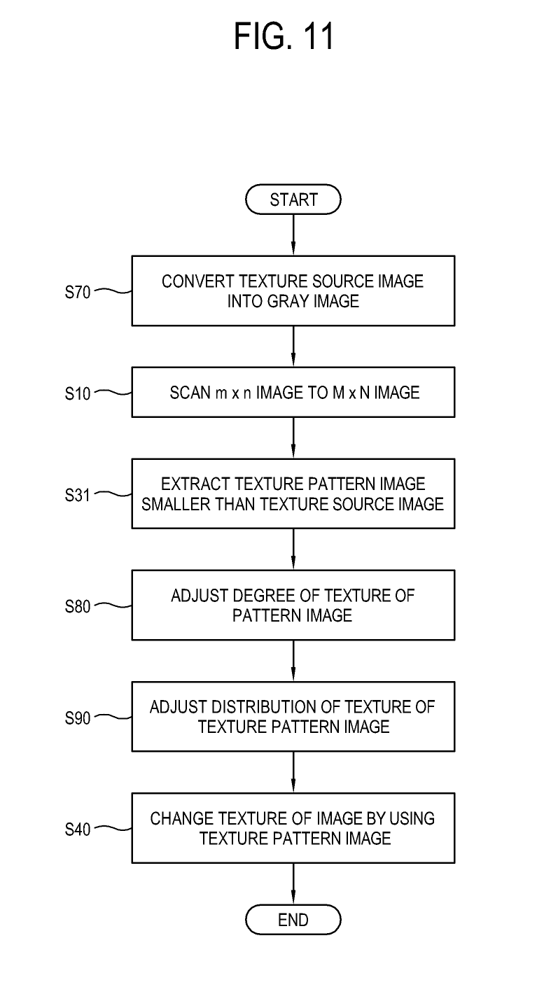

FIG. 11 is a control flowchart of a displaying method of a display apparatus according to an exemplary embodiment. A method of generating a texture pattern image according to the present exemplary embodiment will be described with reference to FIG. 11.

Referring to FIG. 11, if a texture source image is a color image, a gray converter 40 converts the texture source image into a gray image (operation S70).

A pattern extractor 20 extracts a texture pattern image having a smaller size than the texture source image, from the texture source image (operation S31).

The texture of the texture pattern image I is adjusted by a filtering unit 50 (operation S80). The filtering unit 50 may include at least one of a filter to reduce a low frequency and a filter to reinforce a high frequency.

The texture pattern image whose texture is adjusted may be adjusted in distribution of the texture by a histogram unit 60 (operation S90).

The texture pattern image whose texture and distribution of texture is adjusted is used to change the texture of the image by an image processor 30 (operation S40), and the image having various textures is displayed on a display unit 10.

One or more exemplary embodiments provide a method of extracting a texture pattern image from a texture source image so that a user may give various texture effects to an image.

As described above, a display apparatus and a displaying method of the same according to one or more exemplary embodiments occupies less storage space and changes a texture of an image.

Also, a display apparatus and a displaying method of the same according to one or more exemplary embodiments generates a texture pattern image from a texture source image.

Further, a display apparatus and a displaying method of the same according to one or more exemplary embodiments changes a degree of a texture and a distribution of a texture of a texture pattern image.

While not restricted thereto, an exemplary embodiment can be embodied as computer-readable code on a computer-readable recording medium. The computer-readable recording medium is any data storage device that can store data that can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network-coupled computer systems so that the computer-readable code is stored and executed in a distributed fashion. Also, an exemplary embodiment may be written as a computer program transmitted over a computer-readable transmission medium, such as a carrier wave, and received and implemented in general-use or special-purpose digital computers that execute the programs. Moreover, one or more units of the display apparatus can include a processor or microprocessor executing a computer program stored in a computer-readable medium.

Although a few exemplary embodiments have been shown and described, it will be appreciated by those skilled in the art that changes may be made in these exemplary embodiments without departing from the principles and spirit of the inventive concept, the scope of which is defined in the appended claims and their equivalents.

What is claimed is:

1. An image processing apparatus comprising:
a pattern extractor which extracts, from a texture source image, a texture pattern image that is smaller in size than the texture source image; and
an image processor which changes a texture of an image to be displayed by using the extracted texture pattern image.

2. The image processing apparatus according to claim 1, further comprising a display unit which displays the image having the changed texture.

3. The image processing apparatus according to claim 1, wherein:
the texture source image comprises an M×N image (where 1≦M and 1≦N); and
the pattern extractor scans the M×N image with an m×n image (where 1≦m≦M and 1≦n≦N) and extracts, as the texture pattern image, an m×n region of the M×N image according to the scanning in which a sum of absolute difference (SAD) of a top horizontal line and a bottom horizontal line is lowest.

4. The image processing apparatus according to claim 1, wherein:
the texture source image comprises an M×N image (where 1≦M and 1≦N); and
the pattern extractor scans the M×N image with an m×n image (where 1≦m≦M and 1≦n≦N) and extracts, as the texture pattern image, an m×n region of the M×N image according to the scanning in which a SAD of a far left vertical line and a far right vertical line is lowest.

5. The image processing apparatus according to claim 1, wherein:
the texture source image comprises an M×N image (where 1≦M and 1≦N); and
the pattern extractor scans the M×N image with an m×n image (where 1≦m≦M and 1≦n≦N), and calculates a SAD_{H} of top and bottom horizontal lines and a SAD_{V} of far left and far right vertical lines for each m×n region according to the scanning to extract, as the texture pattern image, an m×n region of the M×N image having a lowest value according to:
SAD=αx SAD_{H}+βx SAD_{V}, [Formula 1]
(where 0≦α, β.

6. The image processing apparatus according to claim 1, wherein:
the texture source image comprises an M×N image (where 1≦M and 1≦N); and
the pattern extractor extracts an m×n image (1≦m≦M, 1≦n≦N) from the M×N image, and low-pass-filters pixels in a fringe of the extracted m×n image to generate the texture pattern image.

7. The image processing apparatus according to claim 1, wherein:
the texture source image comprises an M×N image (where 1≦M and 1≦N); and
the pattern extractor extracts an a×b image (where 1≦a≦M and 1≦b≦N) from the M×N image, and interpolates the a×b image to generate an m×n image (where a≦m≦M and b≦n≦N) as the texture pattern image.

8. The image processing apparatus according to claim 1, further comprising a gray image converter which converts the texture source image into a gray image, wherein the pattern extractor extracts the texture pattern image from the gray image.

9. The image processing apparatus according to claim 8, wherein the gray image converter generates the gray image by extracting one of red (R), green (G), and blue (B) components of the texture source image.

10. The image processing apparatus according to claim 8, wherein the gray image converter generates the gray image by extracting a brightness value of the texture source image.

11. The image processing apparatus according to claim 1, further comprising a filtering unit which adjusts a degree of a texture of the texture pattern image.

12. The image processing apparatus according to claim 11, wherein the filtering unit comprises at least one of a low pass filter, a median filter, a high pass filter, and a sharpness filter.

13. The image processing apparatus according to claim 1, further comprising a histogram unit which adjusts a distribution of a texture of the texture pattern image.

14. The image processing apparatus according to claim 13, wherein the histogram unit normalizes a histogram with respect to the number of pixels corresponding to a gray scale value of the texture pattern image, and adjusts at least one of a width and a central axis of the normalized histogram.

15. The image processing apparatus according to claim 1, wherein:
the texture source image comprises an M×N image (where 1≦M and 1≦N); and
the pattern extractor scans the M×N image with an m×n image (where 1≦m≦M and 1≦n≦N) and extracts, as the texture pattern image, an m×n region of the M×N image according to the scanning based on a SAD of a far left vertical line and a far right vertical line and a SAD of a top horizontal line and a bottom horizontal line.

16. A displaying method of a display apparatus, the displaying method comprising:
extracting, from a texture source image, a texture pattern image which is smaller in size than the texture source image; and
changing a texture of an image to be displayed by the display apparatus by using the texture pattern image.

17. The displaying method according to claim 16, wherein:
the texture source image comprises an M×N image (where 1≦M and 1≦N); and
the extracting the texture pattern image comprises scanning the M×N image with an m×n image (where 1≦m≦M and 1≦n≦N), and calculating a SAD_{H} of top and bottom horizontal lines and a SAD_{V} of far left and far right vertical lines for each m×n region according to the scanning to extract a m×n region of the M×N image having a lowest value according to:
SAD=αx SAD_{H}+βx SAD_{V}, [Formula 1]
where 0≦α, β.

18. The displaying method according to claim 16, wherein:
the texture source image comprises an M×N image (where 1≦M and 1≦N); and
the extracting the texture pattern image comprises extracting an m×n image (where 1≦m≦M and 1≦n≦N) from the M×N image, and generating the texture pattern image by low-pass-filtering pixels in a fringe of the extracted m×n image.

19. The displaying method according to claim 16, wherein:
the texture source image comprises an M×N image (where 1≦M and 1≦N); and
the extracting the texture pattern image comprises extracting an a×b image (where 1≦a≦M and 1≦b≦N) from the M×N image, and generating an m×n image (where a≦m≦M and b≦n≦N) as the texture pattern image by interpolating the a×b image.

20. The displaying method according to claim 16, further comprising converting the texture source image into a gray image.

21. The displaying method according to claim 16, further comprising adjusting a degree of a texture of the texture pattern image.

22. The displaying method according to claim 16, further comprising adjusting a distribution of a texture of the texture pattern image.
